(19) United States
(12) Patent Application Publication
(10) Pub. No.: US 2023/0235790 A1
(43) Pub. Date: Jul. 27, 2023

(54) ECCENTRIC SHAFT LOCKING SYSTEM FOR CIRCULAR SHAFTS

(71) Applicant: Dodge Industrial, Inc., Oxford, CT (US)

(72) Inventors: Thomas Kuckhoff, Greenville, SC (US); Chris England, Laurens, SC (US); Jay Saxon, Russellville, TN (US)

(73) Assignee: Dodge Industrial, Inc., Oxford, CT (US)

(21) Appl. No.: 17/585,429

(22) Filed: Jan. 26, 2022

(51) Int. Cl. F16C 17/02; F16C 33/06

(52) U.S. Cl. CPC F16C 17/02; F16C 33/06

(57) ABSTRACT

A bearing and a shaft locking system for a bearing are disclosed. The bearing includes an inner ring having an opening configured to receive a shaft. The bearing includes a sleeve. The sleeve has a circular bore and an eccentric outer geometry. The sleeve is configured to fit onto the inner ring. The bearing includes a collar. The collar has an eccentric inner geometry. The collar is configured to fit onto the sleeve. In a concentric position, the concentric outer geometry of the sleeve and the eccentric inner geometry of the collar are configured to be offset. In an eccentric position, rotated from the concentric position, the eccentric inner geometry of the collar is configured to force the sleeve onto the inner ring.

### FIELD

This disclosure relates generally to bearings. More particularly, this disclosure relates to a shaft locking system for a rotating shaft.

### BACKGROUND

Bearing assemblies are used in machinery with exposed rotating shafts. Bearing assemblies support rotating shafts to allow rotating mechanical energy to be transmitted and minimize friction between the shafts and stationary machine members. The degree of attaching mechanical equipment to rotating shafts determines the amount of torque that can be transmitted, the ease of installation of equipment, and the ease of disassembly for servicing. Current mechanical fastener designs use multiple setscrews that tighten onto the shaft. Due to the stress created by the setscrews, mechanical stresses in the equipment are often high and can result in premature equipment failure. Improved shaft locking bearing assemblies are desired.

### SUMMARY

In some embodiments, a bearing includes an inner ring having an opening configured to receive a shaft. In some embodiments, the bearing includes a sleeve. In some embodiments, the sleeve has a circular bore and an eccentric outer geometry. In some embodiments, the sleeve is configured to fit onto the inner ring. In some embodiments, the bearing includes a collar. In some embodiments, the collar has an eccentric inner geometry. In some embodiments, the collar is configured to fit onto the sleeve. In some embodiments, in a concentric position, the eccentric outer geometry of the sleeve and the eccentric inner geometry of the collar are configured to be offset. In some embodiments, in an eccentric position, rotated from the concentric position, the eccentric inner geometry of the collar is configured to force the sleeve onto the inner ring.

In some embodiments, the concentric position is an unlocked state. In some embodiments, the eccentric position is a locked state.

In some embodiments, the eccentric position is rotated relative to the concentric position in either of a first direction or a second direction. In some embodiments, the first direction is opposite the second direction. In some embodiments, the first direction corresponds to a first rotational direction of the shaft.

In some embodiments, the inner ring is a flexible inner ring including a plurality of fingers configured to be compressed onto the shaft by the sleeve.

In some embodiments, the inner ring is a rigid inner ring configured to be compressed onto the shaft by the sleeve.

In some embodiments, the sleeve includes a plurality of recesses.

In some embodiments, the collar includes a plurality of set screws.

In some embodiments, in the eccentric position, the plurality of set screws are aligned with the plurality of recesses. In some embodiments, the plurality of set screws include an unlocked state and a locked state. In some embodiments, in the locked state, the plurality of set screws are secured within the plurality of recesses.

In some embodiments, in the locked state, the plurality of set screws and the plurality of recesses are configured to prevent rotation of the collar relative to the sleeve.

In some embodiments, the sleeve includes a sawcut. In some embodiments, a first end of the sleeve and a second end of the sleeve are configured to be moved toward each other in response to a compressive force.

In some embodiments, an assembly includes a sleeve. In some embodiments, the sleeve has a circular bore and an eccentric outer geometry. In some embodiments, the sleeve is configured to fit onto an inner ring of a bearing assembly. In some embodiments, the assembly includes a collar. In some embodiments, the collar has an eccentric inner geometry. In some embodiments, the collar is configured to fit onto the sleeve. In some embodiments, in a concentric position, the eccentric outer geometry of the sleeve and the eccentric inner geometry of the collar are configured to be offset. In some embodiments, in an eccentric position, rotated from the concentric position, the eccentric inner geometry of the collar is configured to force the sleeve onto the inner ring.

In some embodiments, the eccentric position is rotated relative to the concentric position in either of a first direction or a second direction. In some embodiments, the first direction is opposite the second direction.

In some embodiments, the sleeve includes a plurality of recesses. In some embodiments, the collar includes a plurality of set screws.

In some embodiments, in the eccentric position, the plurality of set screws are aligned with the plurality of recesses. In some embodiments, the plurality of set screws include an unlocked state and a locked state, wherein in the locked state, the plurality of set screws are secured within the plurality of recesses.

In some embodiments, an assembly includes a housing having a bore. In some embodiments, the assembly includes a bearing configured to be disposed within the bore. In some embodiments, the assembly includes an inner ring having an opening configured to receive a shaft. In some embodiments, the assembly includes a sleeve. In some embodiments, the sleeve has a circular bore and an eccentric outer geometry. In some embodiments, the sleeve is configured to fit onto the inner ring. In some embodiments, the assembly includes a collar. In some embodiments, the collar has an eccentric inner geometry. In some embodiments, the collar is configured to fit onto the sleeve. In some embodiments, in a concentric position, the eccentric outer geometry of the sleeve and the eccentric inner geometry of the collar are configured to be offset. In some embodiments, in an eccentric position, rotated from the concentric position, the eccentric inner geometry of the collar is configured to force the sleeve onto the inner ring.

In some embodiments, the concentric position is an unlocked state. In some embodiments, the eccentric position is a locked state.

In some embodiments, the eccentric position is rotated relative to the concentric position in either of a first direction or a second direction. In some embodiments, the first direction is opposite the second direction. In some embodiments, the first direction corresponds to a first rotational direction of the shaft.

### BRIEF DESCRIPTION OF THE DRAWINGS

References are made to the accompanying drawings that form a part of this disclosure and that illustrate embodiments in which the systems and methods described in this Specification can be practiced.

FIG. 1 shows a bearing assembly, according to some embodiments.

FIGS. 2A-2B show an inner ring, according to some embodiments.

FIGS. 3A-3B show an inner ring, according to some embodiments.

FIG. 4 shows a side view of a sleeve of the shaft locking system of FIG. 1, according to some embodiments.

FIG. 5 shows a perspective view of the sleeve of the shaft locking system of FIG. 1, according to some embodiments.

FIG. 6 shows a side view of a collar of the shaft locking system of FIG. 1, according to some embodiments.

FIG. 7 shows a perspective view of the collar of the shaft locking system of FIG. 1, according to some embodiments.

FIG. 8 shows the shaft locking system of FIG. 1 in a concentric position, according to some embodiments.

FIG. 9 shows the shaft locking system of FIG. 1 in an eccentric position, according to some embodiments.

FIG. 10 shows a set screw in an installed position, according to some embodiments.

FIG. 11 shows the set screw of FIG. 10 in an uninstalled position, according to some embodiments.

FIG. 12 shows a partial sectional view of the bearing assembly of FIG. 1, according to some embodiments.

Like reference numbers represent the same or similar parts throughout.

### DETAILED DESCRIPTION

Bearing assemblies support rotating shafts. By supporting rotating shafts, bearings allow rotating mechanical energy to be transmitted. The bearing is fixed to the circular shaft to allow the shaft rotation to be supported by the bearing rolling elements without sliding between the bearing assembly and the shaft, which can cause bearing failure. Typical bearing shaft attachments include an inner ring of the bearing, or a ring that is composed of the inner raceway of the bearing.

Typically, bearing shaft attachment uses setscrews, which thread through the inner ring and engage the shaft directly. Such connection structures often damage the shaft, where localized marring of the shaft material is caused by the tip of the setscrew. Shaft damage is a result of the setscrews passing through bearing rigid collars and inner rings to deform the surface of the shaft through high torque values on the setscrews. This deformation of the shaft creates obstacles when removing the bearing as the inner rings cannot easily pass over the deformed material of the shaft, which often results in the entire bearing assembly being thrown away if one bearing fails or the entire assembly requires hydraulic assistance to remove the failed bearing. This can increase downtime, cost, and complexity for many applications.

Sometimes a bearing can be attached to the shaft without damaging the shaft by using a clamp collar and a flexible inner ring design, which has a reduced shaft holding power relative to setscrews for some applications. The clamp collar uses one or two bolts that connect sections of the collar together, which upon tightening acts as a clamp to tighten the collar onto the flexible inner ring of the bearing which in turn tightens on the shaft. Much like a hose clamp operates, the collar has a C-shape that closes around the flexible collar as the bolt tightens. Because the flexible collar design is susceptible to the limited torque applied to the clamp collar bolt, holding power efficiency losses can result due to elastic deformation of the clamp collar.

Embodiments of the present disclosure are directed to a shaft locking system for a rotating shaft to be used with a bearing assembly. In some embodiments, the shaft locking system can be installed in a short period of time and with minimal tools. In some embodiments, the shaft locking system can be directly installed in the field near the equipment. In some embodiments, the shaft locking system does not damage the shaft. In some embodiments, the shaft locking system does not use additional bolts and can accordingly reduce a likelihood of causing vibrations during rotation of the shaft.

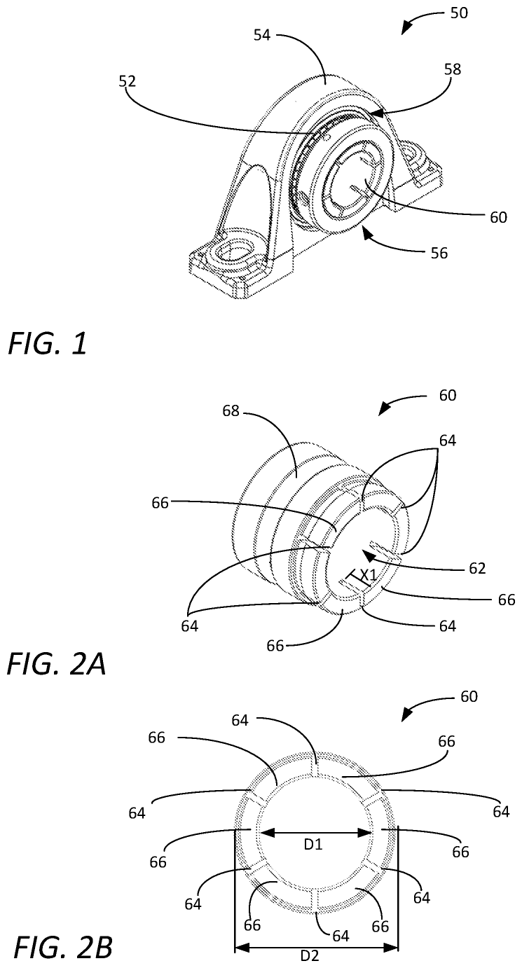

FIG. 1 shows a bearing assembly 50, according to some embodiments. The bearing assembly 50 includes a bearing 52, a bearing housing 54 for the bearing 52, and a shaft locking system 56.

In some embodiments, the bearing assembly 50 can include a pillow block bearing as shown in FIG. 1, or a flanged or take-up bearing assembly configuration. The bearing assembly 50 is generally configured for utilization with a round or circular shaft. In some embodiments, the shaft may be a turned, ground, polished (TGP) shaft or the like. In some embodiments, the shaft locking system 56 may enable usage of a shaft that is not turned, ground, and polished. In some embodiments, the shaft locking system 56 can enable the usage of broader commercially available shafts because the shaft locking system 56 is more adaptable to variations in manufacturing tolerances (e.g., less sensitive to precise tolerance requirements).

In some embodiments, the bearing 52 can include deep groove ball bearings, roller bearings, or the like. The bearing 52 can have an inner ring 60 concentrically disposed with an outer ring with rotational elements therebetween adapted for allowing rotational movement of the inner ring 60 relative to the outer ring.

In some embodiments, the bearing 52 can have an operable speed range of from 3,000 to 15,000 revolutions per minute (RPM). In some embodiments, the bearing 52 can have an operable speed range of 3,000 to 14,000 RPM. In some embodiments, the bearing 52 can have an operable speed range of 3,000 to 13,000 RPM. In some embodiments, the bearing 52 can have an operable speed range of 3,000 to 12,000 RPM. In some embodiments, the bearing 52 can have an operable speed range of 3,000 to 11,000 RPM. In some embodiments, the bearing 52 can have an operable speed range of 3,000 to 10,000 RPM. In some embodiments, the bearing 52 can have an operable speed range of 3,000 to 9,000 RPM. In some embodiments, the bearing 52 can have an operable speed range of 3,000 to 8,000 RPM. In some embodiments, the bearing 52 can have an operable speed range of 3,000 to 7,000 RPM. In some embodiments, the bearing 52 can have an operable speed range of 3,000 to 6,000 RPM. In some embodiments, the bearing 52 can have an operable speed range of 3,000 to 5,000 RPM. In some embodiments, the bearing 52 can have an operable speed range of 3,000 to 4,000 RPM.

In some embodiments, the bearing 52 can have an operable speed range of 4,000 RPM to 15,000 RPM. In some embodiments, the bearing 52 can have an operable speed range of 5,000 RPM to 15,000 RPM. In some embodiments, the bearing 52 can have an operable speed range of 6,000 to 15,000 RPM. In some embodiments, the bearing 52 can have an operable speed range of 7,000 RPM to 15,000 RPM. In some embodiments, the bearing 52 can have an operable speed range of 8,000 RPM to 15,000 RPM. In some embodiments, the bearing 52 can have an operable speed range of 9,000 RPM to 15,000 RPM. In some embodiments, the bearing 52 can have an operable speed range of 10,000 RPM to 15,000 RPM. In some embodiments, the bearing 52 can have an operable speed range of 11,000 RPM to 15,000 RPM. In some embodiments, the bearing 52 can have an operable speed range of 12,000 RPM to 15,000 RPM. In some embodiments, the bearing 52 can have an operable speed range of 13,000 RPM to 15,000 RPM. In some embodiments, the bearing 52 can have an operable speed range of 14,000 to 15,000 RPM. It is to be appreciated that these speed ranges are examples and the actual speed of the bearing 52 can vary beyond the stated ranges.

The bearing housing 54 can be solid or split. The bearing assembly 50 can be sealed or be provided with re-lubrication features. The bearing assembly 50 can be provided as a unit with the bearing 52 factory installed in the bearing housing 54. The bearing 52 can be supplied separately to be assembled by an end-user with the bearing housing 54, as needed. The materials used in connection with the bearing assembly 50 widely vary depending upon the application, and may include polymers, steels, iron, other cast materials, combinations thereof, or the like.

The bearing housing 54 has a bore 58. The bore 58 can be sized and shaped to accommodate the bearing 52. When the bearing assembly 50 is assembled and the bearing 52 is constrained in the bore 58, the bearing 52 can be maintained in position within the bearing assembly 50. The bearing housing 54 can have a hole for accepting a lubrication fitting that extends through the bore 58 to allow the fitting to be placed in register with lubrication ports formed on the bearing 52.

In some embodiments, the shaft locking system 56 can provide for improved locking of a shaft to the bearing 52 that can minimize equipment imbalances, can reduce the risk of decoupling during reversing, and can provide increased holding power. For example, in some embodiments, the shaft locking system 56 can be installed with limited tools. In some embodiments, the shaft locking system 56 can be used without modifying the shaft. In some embodiments, the shaft locking system 56 provides a stronger attachment between the bearing 52 and the shaft than prior locking systems. In some embodiments, an axis of rotation of the shaft can be substantially colinear with an axis of rotation of the shaft locking system 56. In some embodiments, the shaft locking system 56 can have fewer parts than prior locking systems. In some embodiments, the shaft locking system 56 does not contact the shaft. In some embodiments, the shaft locking system 56 can be used with mounted bearings, a gearbox, a shaft enclosure, or the like.

The bearing assembly 50 includes an inner ring 60. The inner ring 60 receives a shaft when installed for use. In the illustrated embodiment, the inner ring 60 includes a plurality of channels 64. As a result, the inner ring 60 may be flexible to receive shafts having slightly varied sizes. The inner ring 60 is shown and described in additional detail in accordance with FIGS. 2A-2B below.

FIGS. 2A-2B show the inner ring 60, according to some embodiments. The inner ring 60 can be used in the bearing assembly 50 (FIG. 1).

In some embodiments, the inner ring 60 is a cylindrical shaped body having an opening 62. The opening 62 is sized and shaped to receive a rotatable shaft for equipment such as, but not limited to, agricultural equipment, fans, industrial equipment, or the like. In some embodiments, the shaft can have a diameter of 0.5 inches to 14 inches.

In some embodiments, the shaft can have a diameter of 0.5 inches to 13 inches. In some embodiments, the shaft can have a diameter of 0.5 inches to 12 inches. In some embodiments, the shaft can have a diameter of 0.5 inches to 11 inches. In some embodiments, the shaft can have a diameter of 0.5 inches to 10 inches. In some embodiments, the shaft can have a diameter of 0.5 inches to 9 inches. In some embodiments, the shaft can have a diameter of 0.5 inches to 8 inches. In some embodiments, the shaft can have a diameter of 0.5 inches to 7 inches. In some embodiments, the shaft can have a diameter of 0.5 inches to 6 inches. In some embodiments, the shaft can have a diameter of 0.5 inches to 5 inches. In some embodiments, the shaft can have a diameter of 0.5 inches to 4 inches. In some embodiments, the shaft can have a diameter of 0.5 inches to 3 inches. In some embodiments, the shaft can have a diameter of 0.5 inches to 2 inches. In some embodiments, the shaft can have a diameter of 0.5 inches to 1 inch. It is to be appreciated that these ranges are examples, and the actual diameter of the shaft can vary beyond the stated ranges.

In some embodiments, the shaft can have a diameter of 1 inch to 14 inches. In some embodiments, the shaft can have a diameter of 2 inches to 14 inches. In some embodiments, the shaft can have a diameter of 3 inches to 14 inches. In some embodiments, the shaft can have a diameter of 4 inches to 14 inches. In some embodiments, the shaft can have a diameter of 5 inches to 14 inches. In some embodiments, the shaft can have a diameter of 6 inches to 14 inches. In some embodiments, the shaft can have a diameter of 7 inches to 14 inches. In some embodiments, the shaft can have a diameter of 8 inches to 14 inches. In some embodiments, the shaft can have a diameter of 9 inches to 14 inches. In some embodiments, the shaft can have a diameter of 10 inches to 14 inches. In some embodiments, the shaft can have a diameter of 11 inches to 14 inches. In some embodiments, the shaft can have a diameter of 12 inches to 14 inches. In some embodiments, the shaft can have a diameter of 13 inches to 14 inches. It is to be appreciated that these ranges are examples, and the actual diameter of the shaft can vary beyond the stated ranges.

In some embodiments, the opening 62 of the inner ring 60 can be larger than the diameter of the shaft. In some embodiments, the opening 62 of the inner ring can be collapsible due to a plurality of channels 64 being formed in the inner ring 60. The channels 64 can be formed a distance X1 from an end of the inner ring 60. In some embodiments, the shaft locking system 56 can be used to force the inner ring 60 inward (e.g., toward the shaft) and to hold the shaft and prevent the shaft from slipping relative to the inner ring 60. This provides increased holding power by the inner ring 60 on the shaft and can minimize equipment imbalance and can reduce the risk of decoupling during reversing, all while adding flexibility to equipment which the bearing assembly 50 attaches onto.

In some embodiments, the channels 64 divide the inner ring 60 into a plurality of fingers 66. The plurality of fingers 66 can flex to accommodate a corresponding shaft. Accordingly, a manufacturing tolerance can be relaxed between the shaft and a diameter D1 of the opening 62. In the illustrated embodiment, the inner ring 60 includes six of the channels 64 and six of the fingers 66. It is to be appreciated that the number of channels 64, and accordingly the number of fingers 66 can vary beyond the illustrated example. For example, in some embodiments, the inner ring 60 can include more than six of the channels 64, and thus more than six of the fingers 66. In some embodiments, the inner ring 60 can include fewer than six of the channels 64, and thus fewer than six of the fingers 66. In some embodiments, the plurality of channels 64 and the plurality of fingers 66 can provide concentric force from the shaft locking system 56 to engage the shaft bore without placing undue mechanical stress on the attached equipment or creating an inherent imbalance in the rotating equipment.

In some embodiments, the inner ring 60 can be referred to as a flexible inner ring or can be referred to as having a flexible equipment opening.

In some embodiments, the inner ring 60 can have an outer diameter D2. The outer diameter D2 may be determined by, for example, a thickness of the material for the inner ring 60. The diameter D2 may be based on, for example, a diameter of the outer ring of the bearing 52 (FIG. 1). In some embodiments, the inner ring 60 includes a channel 68 to accommodate the rotational elements between the inner ring 60 and the outer ring of the bearing 52.

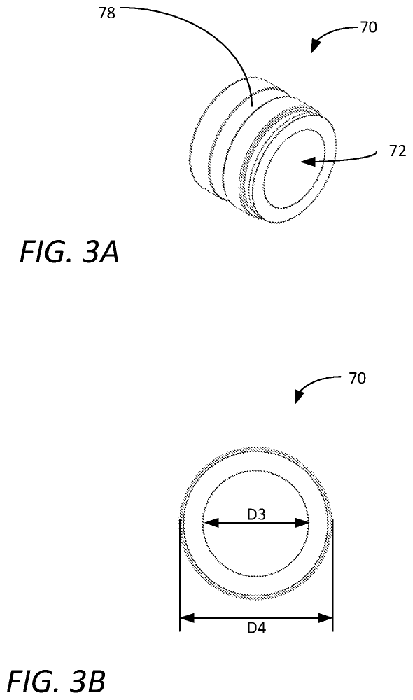

FIGS. 3A-3B shows an inner ring 70, according to some embodiments. The inner ring 70 can be used in place of the inner ring 60 in the bearing assembly 50 (FIG. 1), according to some embodiments. Features of the inner ring 70 can be the same as or similar to features of the inner ring 60 (FIGS. 2A-2B), according to some embodiments.

In some embodiments, the inner ring 70 is a cylindrical shaped body having an opening 72. The opening 72 is sized and shaped to receive a rotatable shaft for equipment such as, but not limited to, agricultural equipment, fans, industrial equipment, or the like. In some embodiments, the shaft can have a diameter of 0.5 inches to 14 inches.

In some embodiments, the shaft can have a diameter of 0.5 inches to 13 inches. In some embodiments, the shaft can have a diameter of 0.5 inches to 12 inches. In some embodiments, the shaft can have a diameter of 0.5 inches to 11 inches. In some embodiments, the shaft can have a diameter of 0.5 inches to 10 inches. In some embodiments, the shaft can have a diameter of 0.5 inches to 9 inches. In some embodiments, the shaft can have a diameter of 0.5 inches to 8 inches. In some embodiments, the shaft can have a diameter of 0.5 inches to 7 inches. In some embodiments, the shaft can have a diameter of 0.5 inches to 6 inches. In some embodiments, the shaft can have a diameter of 0.5 inches to 5 inches. In some embodiments, the shaft can have a diameter of 0.5 inches to 4 inches. In some embodiments, the shaft can have a diameter of 0.5 inches to 3 inches. In some embodiments, the shaft can have a diameter of 0.5 inches to 2 inches. In some embodiments, the shaft can have a diameter of 0.5 inches to 1 inch. It is to be appreciated that these ranges are examples, and the actual diameter of the shaft can vary beyond the stated ranges.

In some embodiments, the shaft can have a diameter of 1 inch to 14 inches. In some embodiments, the shaft can have a diameter of 2 inches to 14 inches. In some embodiments, the shaft can have a diameter of 3 inches to 14 inches. In some embodiments, the shaft can have a diameter of 4 inches to 14 inches. In some embodiments, the shaft can have a diameter of 5 inches to 14 inches. In some embodiments, the shaft can have a diameter of 6 inches to 14 inches. In some embodiments, the shaft can have a diameter of 7 inches to 14 inches. In some embodiments, the shaft can have a diameter of 8 inches to 14 inches. In some embodiments, the shaft can have a diameter of 9 inches to 14 inches. In some embodiments, the shaft can have a diameter of 10 inches to 14 inches. In some embodiments, the shaft can have a diameter of 11 inches to 14 inches. In some embodiments, the shaft can have a diameter of 12 inches to 14 inches. In some embodiments, the shaft can have a diameter of 13 inches to 14 inches. It is to be appreciated that these ranges are examples, and the actual diameter of the shaft can vary beyond the stated ranges.

In some embodiments, the opening 72 of the inner ring 70 can be larger than the diameter of the shaft. Unlike the inner ring 60 (FIGS. 2A-2B), the inner ring 70 does not include the plurality of channels 64 or the plurality of fingers 66. In some embodiments, the shaft locking system 56 can be used to force the inner ring 70 inward (e.g., toward the shaft) and to hold the shaft and prevent the shaft from slipping relative to the inner ring 70. A manufacturing tolerance may be tighter between the shaft and a diameter D3 of the opening 72 because of the rigidity of the inner ring 70.

In some embodiments, the inner ring 70 can be referred to as a rigid inner ring or can be referred to as having a rigid equipment opening.

In some embodiments, the inner ring 70 can have an outer diameter D4. The outer diameter D4 may be determined by, for example, a thickness of the material for the inner ring 70. The diameter D4 may be based on, for example, a diameter of the outer ring of the bearing 52 (FIG. 1). In some embodiments, the inner ring 70 includes a channel 78 to accommodate the rotational elements between the inner ring 70 and the outer ring of the bearing 52.

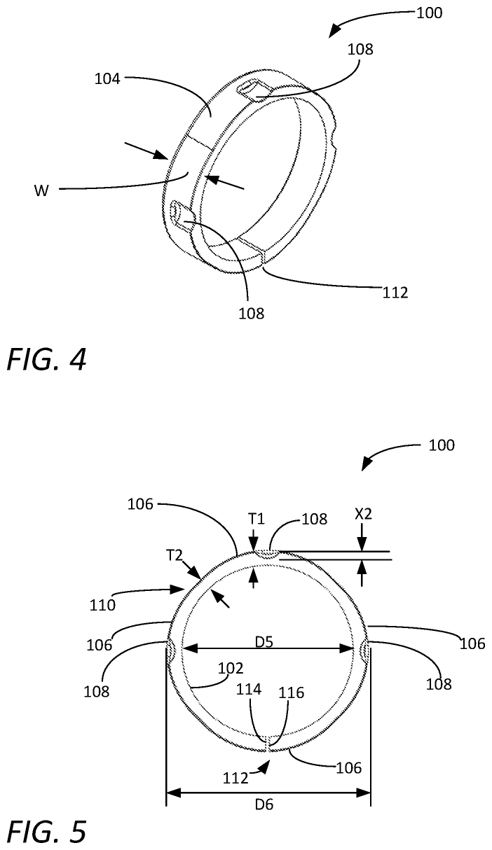

FIG. 4 shows a perspective view of a sleeve 100 of the shaft locking system 56 (FIG. 1), according to some embodiments. FIG. 5 shows a side view of a sleeve of the shaft locking system 56, according to some embodiments. FIGS. 4-5 will be referenced collectively unless specific reference is made otherwise.

In some embodiments, the sleeve 100 includes a circular inner surface 102 and an outer circumference 104 having a plurality of lobes 106. The outer circumference 104 is thus not circular. In some embodiments, the sleeve 100 has an eccentric outer geometry. At each of the lobes 106, the sleeve 100 includes a recess 108. In some embodiments, the recess 108 can be referred to as a blind hole or the like.

The sleeve 100 has an inner diameter D5 and an outer diameter D6. The inner diameter D5 is sized to be larger than the diameter D2 of the inner ring 60 (FIGS. 2A-2B) or the diameter D4 of the inner ring 70 (FIGS. 3A-3B). As such, the sleeve 100 is configured to fit over the inner ring 60 or the inner ring 70.

In the illustrated embodiment, the sleeve 100 includes four of the lobes 106. At each of the lobes 106, a thickness T1 of the sleeve 100 is thicker than a thickness T2 of the sleeve 100 at areas 110 between the lobes 106. In the illustrated embodiment, the sleeve 100 includes four of the lobes 106. In some embodiments, a number of the lobes 106 can be selected so that the sleeve 100 is symmetrical along the diameter D5 of the sleeve 100. In some embodiments, the number of the lobes 106 can be less than four. For example, in some embodiments, the sleeve 100 can have one, two, or three of the lobes 106. In some embodiments, the sleeve 100 can have more than four of the lobes 106. In some embodiments, four of the lobes 106 can provide a balance between a strength of the shaft locking system 56 and a manufacturing complexity of the sleeve 100.

In the illustrated embodiment, the sleeve 100 includes the recess 108 at each of the lobes 106. In some embodiments, the 108 can have a depth X2. In some embodiments, the depth X2 is less than a thickness of the sleeve 100. That is, the recess 108 can be a blind hole. The recess 108 is configured to receive a set screw. In some embodiments, the recess 108 can be formed in a part of the width W of the sleeve 100. In some embodiments, the recess 108 does not extend across the entire width W of the sleeve 100. As a result, a portion of the recess 108 can provide a stop in a longitudinal direction of the sleeve 100.

In some embodiments, the ratio of the recess 108 to the lobes 106 can be less than 1 to 1. For example, in the illustrated embodiment, instead of the recess 108 at one of the lobes 106, the sleeve 100 includes a sawcut 112. In some embodiments, the sawcut 112 can provide for the sleeve 100 to be discontinuous. In some embodiments, the sawcut 112 allows for end 114 and end 116 of the sleeve 100 to be compressed toward each other when a compressive force is applied to the lobes 106. In some embodiments, the sawcut 112 can allow for relaxing of the manufacturing tolerances between the diameter D5 and the diameter D2 (FIGS. 2A-2B) or D4 (FIGS. 3A-3B). In some embodiments, the sleeve 100 can have a press fit on the shaft when installed with the bearing assembly 50.

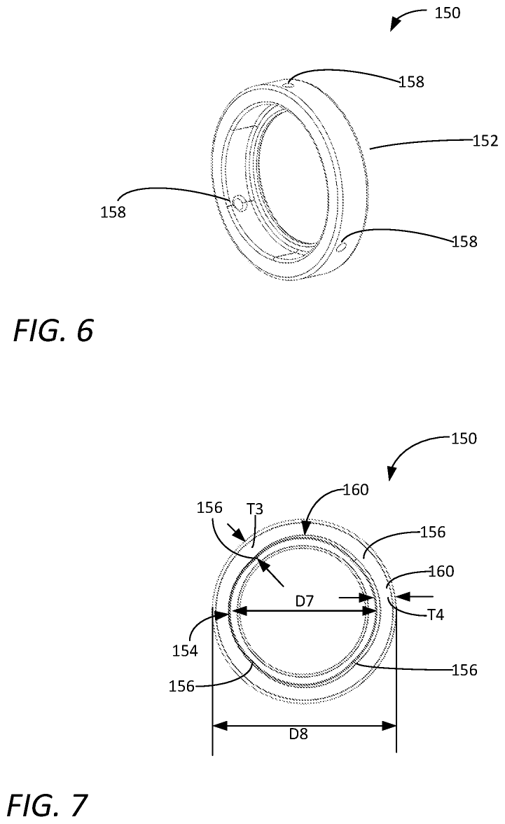

FIG. 6 shows a side view of a collar 150 of the shaft locking system 56 (FIG. 1), according to some embodiments. FIG. 7 shows a perspective view of the collar 150 of the shaft locking system 56, according to some embodiments. FIGS. 6-7 will be referenced collectively unless specific reference is made otherwise.

In some embodiments, the collar 150 includes a circular outer surface 152 and an inner circumference 154 having a plurality of lobes 156. The inner circumference 154 is thus not circular. In some embodiments, the collar 150 has an eccentric inner geometry. At each of the lobes 156, the collar 150 includes an aperture 158. In some embodiments, the aperture 158 can include a set screw. Thus, in some embodiments, the number of set screws can equal the number of lobes 156 on the collar 150. For example, in some embodiments, the collar 150 can have four of the lobes 156 equidistant around the collar 150 spaced 90 degrees apart. Each of the four lobes 156 can include an aperture 158 located on each of the lobes 156 also spaced 90 degrees apart. Each aperture 158 can include a set screw. In some embodiments, the spacing of the lobes 156, aperture 158, and set screws on the collar 150 can depend on the number of lobes 156 on the collar 150. For example, the collar can have three of the lobes 156 spaced 120 degrees apart. Consequently, the position of the aperture 158 and the set screws corresponds to the location of the lobes 156 on the collar 150.

The collar 150 has an inner diameter D7. The inner diameter D7 is sized to be larger than the diameter D6 of the sleeve 100 (FIGS. 6-7). As such, the collar 150 is configured to fit over the sleeve 100.

In the illustrated embodiment, the collar 150 includes four of the lobes 156. In some embodiments, the number of the lobes 156 is selected based on the number of the lobes 106 (FIGS. 4-5) of the sleeve 100. At each of the lobes 156, a thickness T3 of the collar 150 is thicker than a thickness T4 of the collar 150 at areas 160 between the lobes 156. In the illustrated embodiment, the collar 150 includes four of the lobes 156. In some embodiments, a number of the lobes 156 can be selected so that the collar 150 is symmetrical along the diameter D4 of the collar 150. In some embodiments, the number of the lobes 156 can be less than four. For example, in some embodiments, the collar 150 can have one, two, or three of the lobes 156. In some embodiments, the collar 150 can have more than four of the lobes 156. In some embodiments, four of the lobes 156 can provide a balance between a strength of the shaft locking system 56 and a manufacturing complexity of the collar 150.

In some embodiments, the collar 150 includes the aperture 158 at each of the lobes 156. In some embodiments, the ratio of the aperture 158 to the lobes 156 can be less than 1 to 1. In some embodiments, one of the aperture 158 can be included. In some embodiments, the collar 150 can include an additional aperture configured to receive an installation tool or the like.

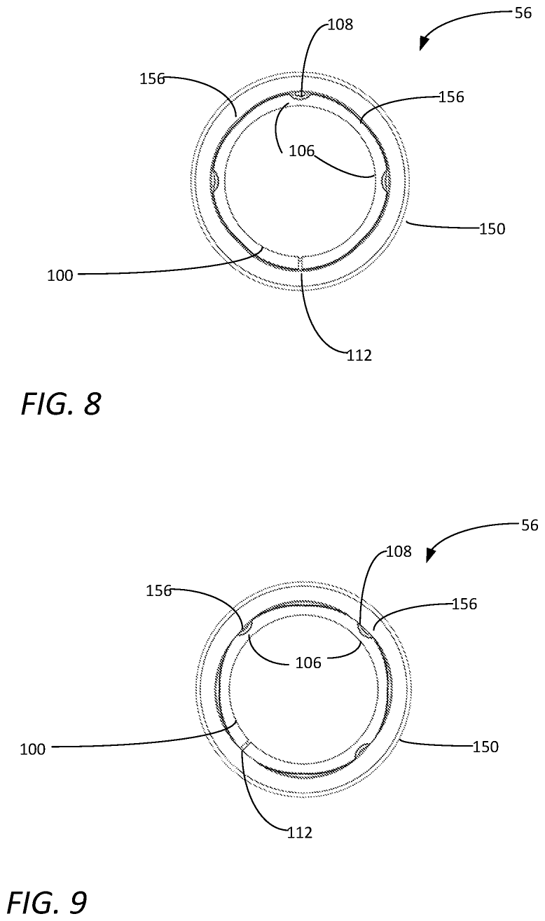

FIG. 8 shows the shaft locking system 56 in a concentric position, according to some embodiments. In the concentric position, the collar 150 is installed over the sleeve 100 so that the collar 150 surrounds the sleeve 100 about a circumference of the sleeve 100. In some embodiments, the concentric position can be a position in which the shaft locking system 56 is in an unlocked state.

In the concentric position, the lobes 106 of the sleeve 100 are offset from the lobes 156 of the collar 150. That is, the lobes 106 of the sleeve 100 are aligned with thinner portions of the collar 150 and the lobes 156 of the collar 150 are aligned with thinner portions of the sleeve 100. In the concentric position, the recess 108 and the aperture 158 are offset from each other.

FIG. 9 shows the shaft locking system 56 in an eccentric position, according to some embodiments.

In some embodiments, in the eccentric position, the collar 150 is installed over the sleeve 100 so that the collar 150 surrounds the sleeve 100 about the circumference of the sleeve 100. In some embodiments, the eccentric position can be a position in which the 56 is in a locked state.

In the eccentric position, the lobes 106 of the sleeve 100 are aligned and abut the lobes 156 of the collar 150. As a result, a compressive force is applied to the sleeve 100 and the sleeve 100 is secured to the shaft. In the eccentric position, the recess 108 and the aperture 158 are aligned with each other. As such, in the eccentric position, the set screws can be tightened to prevent the collar 150 from slipping relative to the sleeve 100.

In some embodiments, to transition from the concentric position to the eccentric position (FIG. 9), the collar 150 is rotated relative to the sleeve 100. In some embodiments, a direction of the rotation is not critical. As such, the shaft locking system 56 may be easy to use as it is not dependent upon a particular installation direction. In some embodiments, in the eccentric position, the lobes 106 and the lobes 156 contact each other, and the result is a compressive force applied to the sleeve 100 and thus the shaft. In some embodiments, an amount of rotation to move from the concentric position to the eccentric position may be a small amount. For example, in some embodiments, an amount of rotation can be from 5° to 15°. In some embodiments, the amount of rotation can be from 5° to 14°. In some embodiments, the amount of rotation can be from 5° to 13°. In some embodiments, the amount of rotation can be from 5° to 12°. In some embodiments, the amount of rotation can be from 5° to 11°. In some embodiments, the amount of rotation can be from 5° to 10°. In some embodiments, the amount of rotation can be from 5° to 9°. In some embodiments, the amount of rotation can be from 5° to 8°. In some embodiments, the amount of rotation can be from 5° to 7°. In some embodiments, the amount of rotation can be from 5° to 6°.

In some embodiments, the amount of rotation can be from 6° to 15°. In some embodiments, the amount of rotation can be from 7° to 15°. In some embodiments, the amount of rotation can be from 8° to 15°. In some embodiments, the amount of rotation can be from 9° to 15°. In some embodiments, the amount of rotation can be from 10° to 15°. In some embodiments, the amount of rotation can be from 11° to 15°. In some embodiments, the amount of rotation can be from 12° to 15°. In some embodiments, the amount of rotation can be from 13° to 15°. In some embodiments, the amount of rotation can be from 14° to 15°.

In some embodiments, the matching eccentric features of the sleeve 100 and the collar 150 allows for quick equipment installation with minimal tools in the field. Furthermore, the eccentric features of the shaft locking system 56 provides for minimized equipment imbalance, improved protection from decoupling during reversing, and increased holding power compared to concentric clamp collar designs.

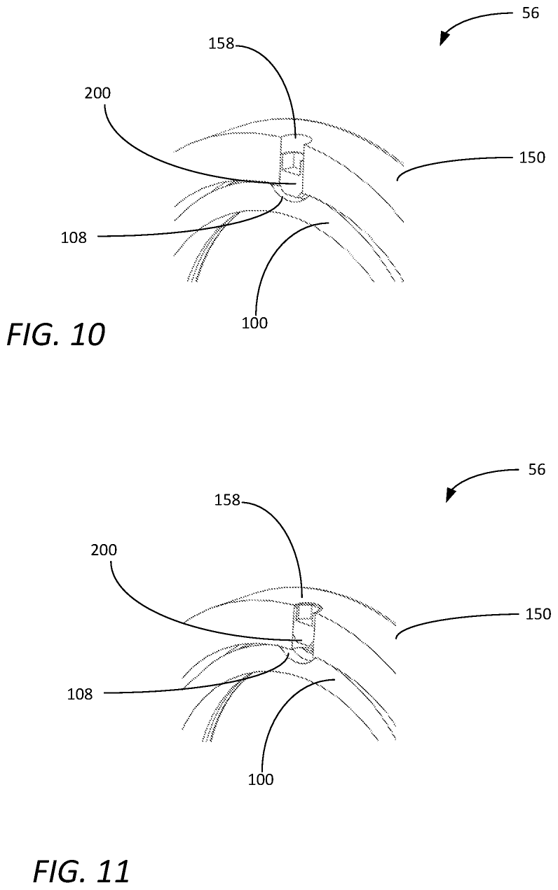

FIG. 10 shows a set screw 200 in a locked position, according to some embodiments. FIG. 11 shows the set screw 200 in an unlocked position, according to some embodiments. FIGS. 10-11 will be discussed collectively unless specific reference is made otherwise. In some embodiments, the set screw 200 can serve as a rotation preventing feature. For example, when the shaft locking system 56 is in the eccentric position, the recess 108 and the aperture 158 are aligned. The set screw 200 can then be moved from the unlocked position (FIG. 11) to the locked position (FIG. 10). In some embodiments, the set screw 200 can be moved from the locked position to the unlocked position, and vice versa, via rotation.

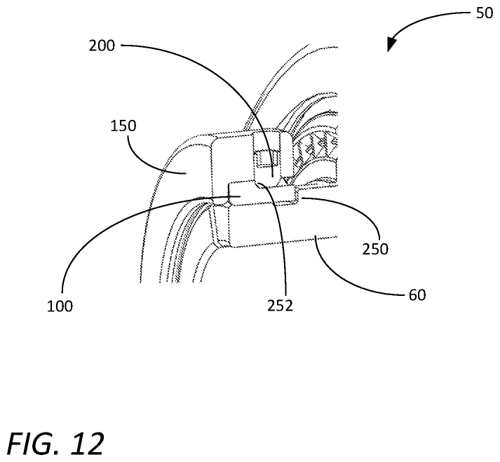

FIG. 12 shows a partial sectional view of the bearing assembly 50, according to some embodiments. In the illustrated embodiment, a shoulder 250 on the inner ring 60 is visible. The shoulder 250 is configured to abut an end surface of the sleeve 100. In some embodiments, a user can push the sleeve 100 onto the inner ring 60 during installation until the sleeve 100 abuts the shoulder 250. Additionally, a shoulder 252 on the recess 108 of the sleeve 100 can prevent the collar 150 from moving away from the bearing 52. In some embodiments, the shoulder 252 can serve as an axial retention feature, to ensure the collar 150 cannot easily slide off the sleeve 100. Thus, the set screw 200 serves to prevent slippage in a rotational direction between the collar 150 and the 100 and the set screw 200 also serves to maintain the collar 150 in its correct axial position relative to the bearing 52.

In some embodiments, a method for locking a shaft in the bearing assembly 50 includes sliding a sleeve 100 over an inner ring 60 or an inner ring 70. The method includes sliding a collar 150 over the sleeve 100. When the collar 150 is slid onto the sleeve 100, the collar 150 and the sleeve 100 are in a concentric position. Once the collar 150 is on the sleeve 100, the collar 150 is rotated relative to the sleeve 100. In some embodiments, the rotation of the collar 150 can be in a clockwise direction. In some embodiments, the rotation of the collar 150 can be in a counterclockwise direction. In some embodiments, to uninstall the shaft locking system 56, the collar 150 can be in the opposite direction as the installation direction.

As a result, the shaft locking system 56 is transitioned from the concentric position to the eccentric position. In the eccentric position, the sleeve 100 is forced onto the inner ring 60 or the inner ring 70. The shaft is then locked to the bearing assembly 50. In some embodiments, to further secure the shaft locking system 56, one or more set screws 200 can be tightened into one or more apertures in the sleeve 100. The set screws can prevent a movement of the collar 150 in the uninstallation direction during operation.

The terminology used herein is intended to describe embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A bearing, comprising:
an inner ring having an opening configured to receive a shaft;
a sleeve,
wherein the sleeve has a circular bore and an eccentric outer geometry,
wherein the sleeve is configured to fit onto the inner ring; and
a collar,
wherein the collar has an eccentric inner geometry,
wherein the collar is configured to fit onto the sleeve;
wherein in a concentric position, the eccentric outer geometry of the sleeve and the eccentric inner geometry of the collar are configured to be offset,
wherein in an eccentric position, rotated from the concentric position, the eccentric inner geometry of the collar is configured to force the sleeve onto the inner ring.

2. The bearing of claim 1, wherein the concentric position is an unlocked state.

3. The bearing of claim 1, wherein the eccentric position is a locked state.

4. The bearing of claim 1, wherein the eccentric position is rotated relative to the concentric position in either of a first direction or a second direction, wherein the first direction is opposite the second direction, and wherein the first direction corresponds to a first rotational direction of the shaft.

5. The bearing of claim 1, wherein the inner ring is a flexible inner ring including a plurality of fingers configured to be compressed onto the shaft by the sleeve.

6. The bearing of claim 1, wherein the inner ring is a rigid inner ring configured to be compressed onto the shaft by the sleeve.

7. The bearing of claim 1, wherein the sleeve comprises a plurality of recesses.

8. The bearing of claim 7, wherein the collar comprises a plurality of set screws.

9. The bearing of claim 8, wherein in the eccentric position, the plurality of set screws are aligned with the plurality of recesses; and wherein the plurality of set screws include an unlocked state and a locked state, wherein in the locked state, the plurality of set screws are secured within the plurality of recesses.

10. The bearing of claim 9, wherein in the locked state, the plurality of set screws and the plurality of recesses are configured to prevent rotation of the collar relative to the sleeve.

11. The bearing of claim 1, wherein the sleeve includes a sawcut, wherein a first end of the sleeve and a second end of the sleeve are configured to be moved toward each other in response to a compressive force.

12. An assembly, comprising:
a sleeve,
wherein the sleeve has a circular bore and an eccentric outer geometry,
wherein the sleeve is configured to fit onto an inner ring of a bearing assembly; and
a collar,
wherein the collar has an eccentric inner geometry,
wherein the collar is configured to fit onto the sleeve;
wherein in a concentric position, the eccentric outer geometry of the sleeve and the eccentric inner geometry of the collar are configured to be offset,
wherein in an eccentric position, rotated from the concentric position, the eccentric inner geometry of the collar is configured to force the sleeve onto the inner ring.

13. The assembly of claim 12, wherein the eccentric position is rotated relative to the concentric position in either of a first direction or a second direction, wherein the first direction is opposite the second direction.

14. The assembly of claim 12, wherein the sleeve comprises a plurality of recesses.

15. The assembly of claim 14, wherein the collar comprises a plurality of set screws.

16. The assembly of claim 15, wherein in the eccentric position, the plurality of set screws are aligned with the plurality of recesses; and wherein the plurality of set screws include an unlocked state and a locked state, wherein in the locked state, the plurality of set screws are secured within the plurality of recesses.

17. An assembly, comprising:
a housing having a bore;
a bearing configured to be disposed within the bore;
an inner ring having an opening configured to receive a shaft;
a sleeve,
wherein the sleeve has a circular bore and an eccentric outer geometry,
wherein the sleeve is configured to fit onto the inner ring; and
a collar,
wherein the collar has an eccentric inner geometry,
wherein the collar is configured to fit onto the sleeve;
wherein in a concentric position, the eccentric outer geometry of the sleeve and the eccentric inner geometry of the collar are configured to be offset,
wherein in an eccentric position, rotated from the concentric position, the eccentric inner geometry of the collar is configured to force the sleeve onto the inner ring.

18. The assembly of claim 17, wherein the concentric position is an unlocked state.

19. The assembly of claim 17, wherein the eccentric position is a locked state.

20. The assembly of claim 17, wherein the eccentric position is rotated relative to the concentric position in either of a first direction or a second direction, wherein the first direction is opposite the second direction, and wherein the first direction corresponds to a first rotational direction of the shaft.
